(19) United States
(12) Patent Application Publication
(10) Pub. No.: US 2019/0118231 A1
(43) Pub. Date: Apr. 25, 2019

(54) ANTI-JAMMING MECHANISM FOR A CLEANING TANK

(71) Applicant: Chemserve Pty Ltd, Alexandria NSW (AU)

(72) Inventor: Michael HEYMAN, Alexandria NSW (AU)

(21) Appl. No.: 16/162,577

(22) Filed: Oct. 17, 2018

(30) Foreign Application Priority Data
Oct. 19, 2017 (AU) 2017101396

(51) Int. Cl. B08B 13/00; A47L 15/02

(52) U.S. Cl. CPC B08B 13/00; A47L 15/0081; A47L 15/02

(57) ABSTRACT

A support frame for a basket in a cleaning tank is attached to a lifting member to raise and lower the basket and also two vertical stabilising members to prevent unwanted movement of the basket when asymmetrically or heavily loaded, which may lead the basket to jam against the sides of the tank. The stabilising members run in guides external to the tank and include skids or wheels for low friction movement. Further rollers attached to the baskets prevent it from fouling against the inside surfaces of the tank.

### FIELD OF THE INVENTION

The present invention relates to an anti-jamming mechanism for an industrial cleaning tank with an automatic lifting mechanism.

### BACKGROUND TO THE INVENTION

Industrial cleaning tanks are becoming more popular in commercial kitchens. They provide a high temperature cleaning bath in which pots, grills, baking trays etcetera are left in for several hours to remove baked on material. For convenient handling the tanks provide a basket for holding the objects to be cleaned. In most tanks the basket is manually placed into the tank and lifted out again. In more advanced tanks a lifting mechanism is provided. Whilst only operating over a short distance, the automatic lifting mechanisms are beneficial as the equipment being cleaned is often very heavy, with loads of 90 kg or more needing to be catered for. Automatic lifting mechanisms are preferably organised with the drive components located outside of the wet and hot environment inside the tank, typically in the surrounding cabinetry with some form of arm connecting to a supporting frame inside the tank for holding the basket. The lifting mechanism is usually placed behind the tank with the connecting arm reaching into the rear of the tank.

It is sometimes difficult to balance the load in a basket, particularly when the items to be cleaned are particularly heavy and oddly shaped. An unbalanced basket puts a lateral load and/or a forward load on the supporting frame, tending to tilt the frame forwards or to one side. This can result in the basket or its contents fouling the tank walls, placing an excessive load on the lifting mechanism or even preventing the basket from being raised or lowered altogether.

The object of this invention is to provide a mechanism to prevent jamming of baskets in a cleaning tank to alleviate the above problem, or at least provide the public with a useful alternative.

### SUMMARY OF THE INVENTION

In a first aspect the invention comprises . . . .

It should be noted that any one of the aspects mentioned above may include any of the features of any of the other aspects mentioned above and may include any of the features of any of the embodiments described below as appropriate.

### BRIEF DESCRIPTION OF THE DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows.

FIG. 1 shows an unloaded industrial cleaning tank with its lid open and basket raised.

FIG. 2 shows the tank with its basket removed to reveal the basket support frame.

FIG. 3 shows the support frame and basket in isolation.

FIG. 4 shows the support frame in isolation from the front.

FIG. 5 shows the support frame from the rear to reveal the anti-jamming mechanism.

FIG. 6 shows the cleaning tank with its lid closed.

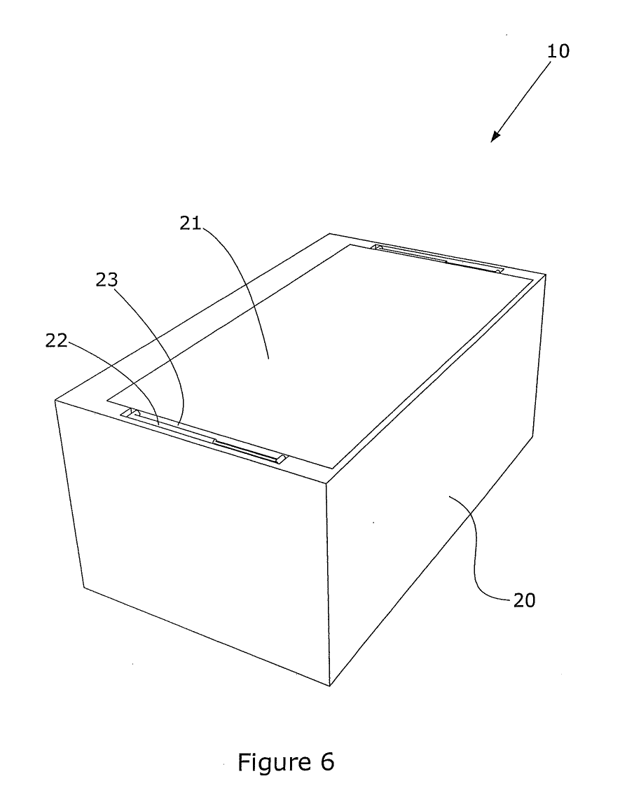

### DRAWING COMPONENTS

The drawings include the following integers.
10 industrial cleaning tank
20 cabinet
21 lid
22 gas strut
23 strut recess
24 lifting guide opening
25 stabiliser guide opening
30 support frame
31 support beam
32 lifting member
33 stabilising member
34 support member
35 slide
36 wheel
37 roller
40 basket
50 internal tank
51 rear wall
52 side wall

### DETAILED DESCRIPTION OF THE INVENTION

The following detailed description of the invention refers to the accompanying drawings. Wherever possible, the same reference numbers will be used throughout the drawings and the following description to refer to the same and like parts. Dimensions of certain parts shown in the drawings may have been modified and/or exaggerated for the purposes of clarity or illustration.

The present invention provides a simple mechanism to prevent unbalanced baskets from jamming in an industrial cleaning tank as they are raised or lowered.

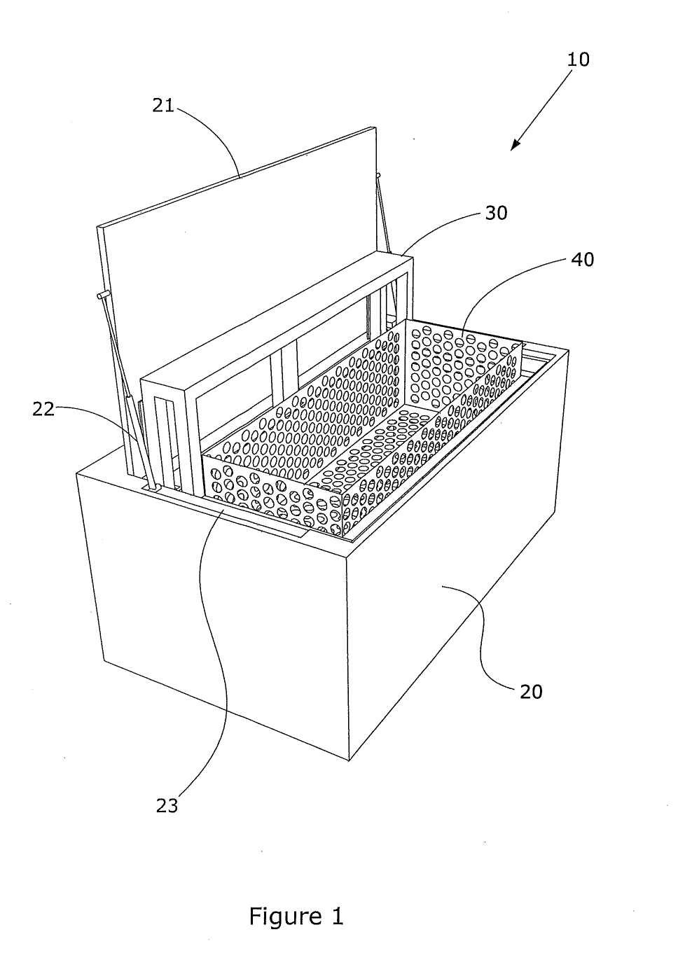

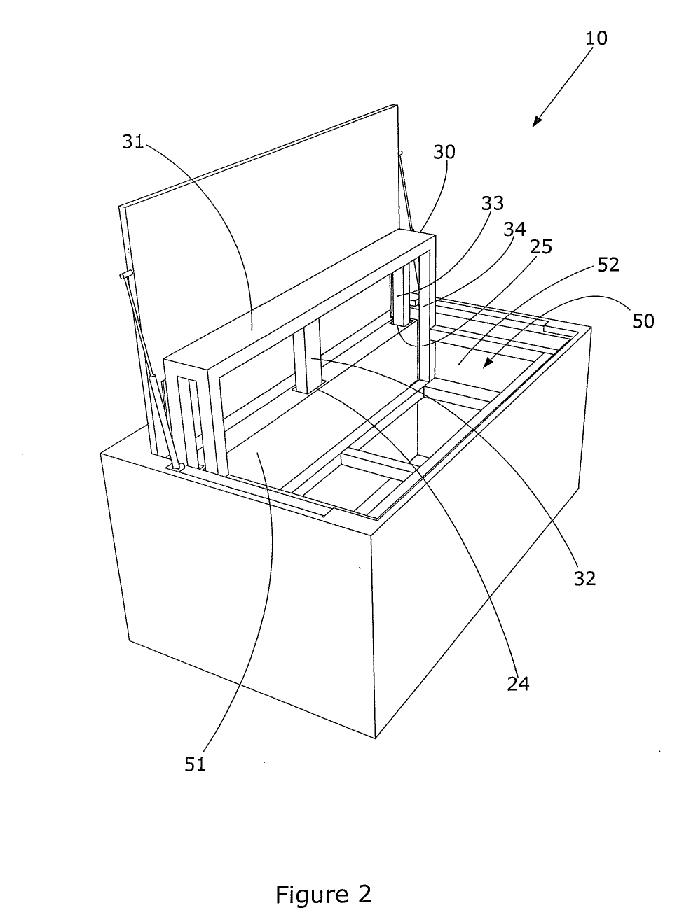

A cleaning tank incorporating the present invention is shown as 10 in FIG. 1. Externally the tank provides a cabinet 20 with a hinged lid 21 supported by gas struts 22. The top of the tank is recessed to accommodate the lid, with recesses 23 accommodating the gas struts when lowered so that the top of the tank provides a flat surface. Inside the tank is an internal tank (shown as 50 in FIG. 2) with a supporting frame 30 holding a cleaning basket 40. The supporting frame is raised and lowered to immerse the cleaning basket into a cleaning mixture.

In FIG. 2 the basket has been removed to reveal how the supporting frame 30 sits partially within the internal tank 50 and partially within the cabinet 20. The supporting frame 30 includes a lifting member 32 and two stabilising members 33 which sit inside the cabinet behind the rear wall 51 of the internal tank and emerge via lifting guide aperture 24 and stabilising guide apertures 25 respectively. Beam 31 joins together the lifting member 32 and stabilising members 33 with support member 34 to which further members are attached for holding the basket. The lifting member and stabilising members are thus kept out of the cleaning solution that fills the internal tank 50.

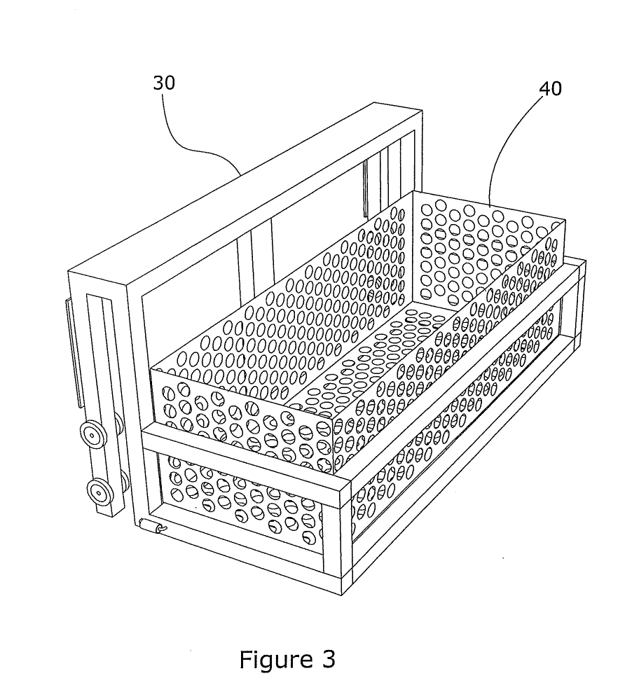

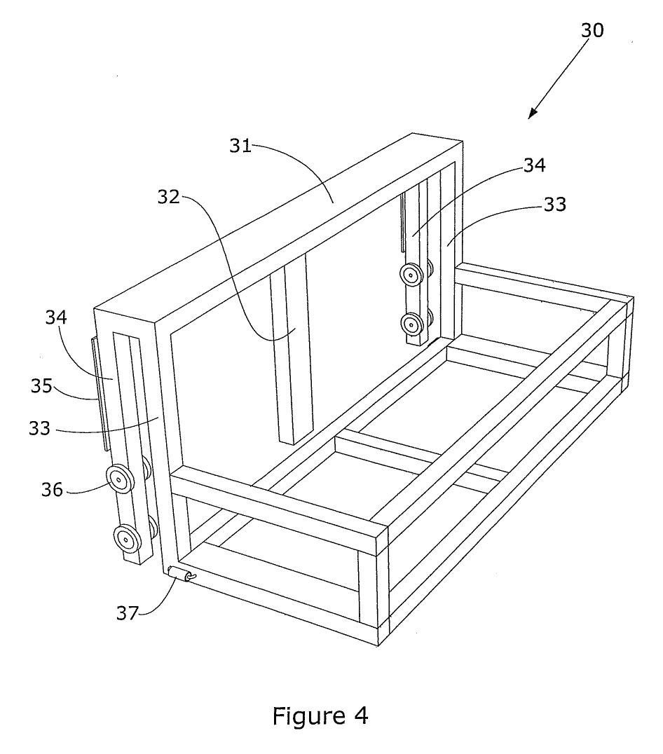

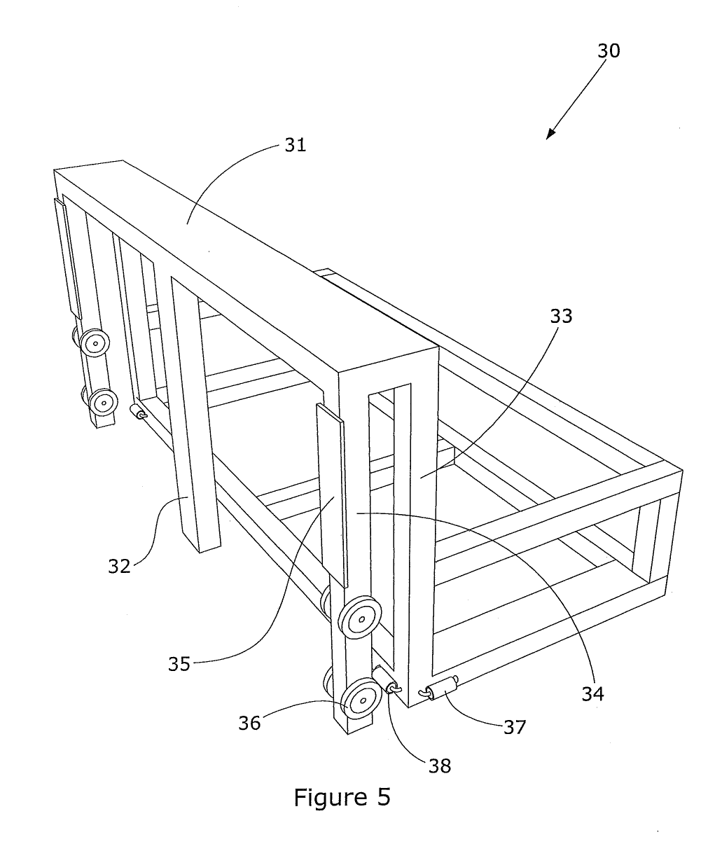

The supporting frame 30 with basket 40 in place is shown removed from the tank in FIG. 3 whilst FIG. 4shows the supporting frame in isolation from a front perspective. FIG. 5 shows the frame in isolation from a rear perspective. The frame is raised and lowered by lifting member 32 which can be driven either electrically or hydraulically as is well known in the art. The lifting member distributes its lifting force via beam 31 to support members 34 which in turn connect to a number of further members for supporting and locating the basket. As the basket is effectively supported from a single point, i.e. the lifting member 32, any load placed in the basket will tend to rotate the basket and support frame forwards. If the load is laterally asymmetric it will also tend to rotate the basket and frame to the side with the greatest load. Such forward or sideways rotation will potentially foul the frame or its contents against the inner walls of the tank. To prevent such fouling several counter-measures have been taken.

The first counter-measure to prevent forward rotation of the support frame 30 is the stabilising members 33 fitted with wheels 36 which run in a vertical guide (not shown) within the cabinet 20. The wheels 36 run against the front and rear walls of the vertical guide thus preventing forward rotation of the stabilising members 33 and the rest of the support frame.

The second counter-measure to prevent sideways rotation of the support frame 30 is the slides 35 fitted to the stabilising members. The slides 35 are sized slightly smaller than the vertical guides so that any minute sideways rotation of the support frame will result in the slides contacting the side walls of the vertical guides thus limiting any further rotation. The slides present a relatively small contact area to the guides thus minimally impeding vertical movement of the support frame.

The first and second counter measures come into effect with loads that are heavy enough to try and rotate the support frame 30. For extremely large loads where there is also a tendency to deform the support frame after the first and/or second counter measures have come into effect, there are third and fourth counter-measures in the form of rollers 37 and 38 attached to the bottom of the support members 34. Rollers 37 limit lateral rotation of the support frame by acting on the inner side walls 52 of the tank. Rollers 38 limit forward rotation of the support frame by acting on the inner rear wall 51 of the tank.

The reader will now appreciate the present invention which provides a simple mechanism to prevent unbalanced baskets from jamming in an industrial cleaning tank as they are raised or lowered.

Further advantages and improvements may very well be made to the present invention without deviating from its scope. Although the invention has been shown and described in what is conceived to be the most practical and preferred embodiment, it is recognized that departures may be made therefrom within the scope of the invention, which is not to be limited to the details disclosed herein but is to be accorded the full scope of the claims so as to embrace any and all equivalent devices and apparatus. Any discussion of the prior art throughout the specification should in no way be considered as an admission that such prior art is widely known or forms part of the common general knowledge in this field.

In the present specification and claims (if any), the word “comprising” and its derivatives including “comprises” and “comprise” include each of the stated integers but does not exclude the inclusion of one or more further integers.

1. An anti-jamming mechanism for a cleaning tank, comprising a basket support frame with vertical support members connected to a lifting member via a support beam, wherein the mechanism further comprises vertical stabilizing arms connected to the support beam, and wherein the vertical stabilizing arms run in guides to prevent unwanted rotation of the basket support frame.

2. The anti-jamming mechanism as in claim 1, wherein the vertical stabilizing arms further comprise wheels for running in the guides.

3. The anti-jamming mechanism as in claim 1, wherein the vertical stabilizing arms further comprise slides for running in the guides.

4. The anti-jamming mechanism as in claim 1, further comprising rollers attached to the basket support frame, wherein the rollers are adapted to run against inside walls of a cleaning tank.
